(19) United States
(12) Patent Application Publication
(10) Pub. No.: US 2019/0150626 A1
(43) Pub. Date: May 23, 2019

(54) PILLOW LIFTING STRUCTURE

(71) Applicant: HSIEN-TA HUANG, Taoyuan City (TW)

(72) Inventor: HSIEN-TA HUANG, Taoyuan City (TW)

(21) Appl. No.: 16/191,441

(22) Filed: Nov. 15, 2018

(30) Foreign Application Priority Data
Nov. 23, 2017 (TW) 106140727

(51) Int. Cl. A47C 20/04; B66F 11/00

(52) U.S. Cl. CPC A47C 20/041; B66F 11/00

(57) ABSTRACT

A pillow lifting structure includes a bottom plate. The bottom plate is provided with a power unit. The power unit is connected to a linking unit. The top of the linking unit is covered with a cover. The power unit actuates to deform the linking unit for adjusting the height of the cover in time so as to adjust the height of the top surface of the pillow. The X-shaped linking unit of the pillow lifting structure is lifted by a driven arcuate gear with a push arm. This action is a direct push, and there is no power consumption. Only a small motor is required for actuation. Space and energy consumption are optimized by the direct push.

### FIELD OF THE INVENTION

The present invention relates to a pillow lifting structure, and more particularly to a mechanical lifting structure for adjusting the height of a pillow.

### BACKGROUND OF THE INVENTION

Sleep takes almost one-third of the time in life, so ideal practical bedding and related sleep products are important for people. In these days, many people have sleep disorders. However, the quality of sleep is very important for people. Only a good quality of sleep can effectively relieve the fatigue of the day and keep physical strength to cope with the busy life the next day. Modern people have heavy work and stress during the day, and many people suffer from sleep disorders. One of the reasons for sleep disorders is the use of an unsuitable pillow. Because each body type is different, for a person with a strong body, the height of the pillow is relatively high; for a person with a thin and small body, the height of the pillow is relatively low. In particular, natural physiological response and health needs cannot maintain a sleeping posture for a long time (such as sleeping on the back). Otherwise, it will cause discomfort and soreness after long-term compression of the load-bearing part. Therefore, when a person sleeps, he/she will naturally change his/her sleeping posture, such as sleeping on his/her back or side, more than one or two times. When a person sleeps on his/her back or side, the spacing between the neck and the bed is different. In fact, when a person sleeps on his/her back, the spacing between the back of the neck and the bed is relatively small, and the height of the pillow needs to be slightly lower. However, when a person sleeps on his/her side, the spacing between the neck/head and the bed will increase due to the lateral shoulder of the human body. As a result, the height of the pillow should be increased to support the head and neck effectively. The height of all the existing pillows in the market cannot be adjusted. Some pillows have a pillow surface with different height areas. However, the human body can't automatically align one of the different height areas after falling asleep. Especially, when a person sleeps for a long time, it is easy to cause poor blood circulation and cause many questions. Obviously, the existing pillow that cannot automatically adjust the height of the pillow relative to the sleeping posture cannot avoid the above disadvantages or solve the sleep problem, and cannot meet the physiological needs of the human body to obtain a better sleep quality.

Accordingly, the inventor of the present invention has devoted himself based on his many years of practical experiences to solve this problem.

### SUMMARY OF THE INVENTION

In order to make the height adjusting structure of the pillow more desirable, the primary object of the present invention is to provide a pillow lifting structure, which is characterized in that a small motor cooperates with a simple mechanism to achieve the purpose of adjusting the height of a pillow. The present invention has the advantages of small volume, light weight, low cost and the like.

Through the above object, the advantage of the present invention is that the height of the pillow can be adjusted according to different users or different sleeping postures. With the human body detection, the optimal height of the pillow can be automatically adjusted in time to meet the human body's sleep comfort and improve sleep quality.

In order to achieve the above object, the pillow lifting structure of the present invention comprises a bottom plate. The bottom plate is provided with a power unit. The power unit is connected to a linking unit. The top of the linking unit is covered with a cover.

The power unit is disposed on the bottom plate. The power unit includes a motor. An output end of the motor is connected to a speed reducer. An output end of the speed reducer is connected to a driving gear. The driving gear is meshed with a driven arcuate gear. A rotating shaft portion is disposed at the arc center of the driven arcuate gear. The rotating shaft portion is axially mounted to a fixing seat beside the speed reducer. The driven arcuate gear is connected with a push arm. The distal end of the push arm is provided with a pulley.

The linking unit includes a first body and a second body. The first body is in the form of a Chinese character “ [symbol] ”. The second body is in the form of a Chinese character “ [symbol] ”. The first body and the second body are engaged with each other to form an X shape. Two ends of a lower side of the first body are provided with first pulleys. One side of the first body is provided with a side plate. A side pulley is connected to the distal end of the side plate. The bottom surface of the first body is provided with a guide rail. The guide rail is provided with a wear plate. The wear plate is located on the top edge of the pulley of the push arm of the power unit. Two ends of a higher side of the second body are provided with second pulleys.

A central hinge is provided at the junction of the first body and the second body. The central hinge provides deformation of the first body and the second body.

The bottom plate is a flat plate. The bottom plate is provided with at least one second hinge connected to the lower side of the second body. The at least one second hinge provides axial movement of the second body relative to the bottom plate. The bottom plate is provided with a potentiometer. The side pulley can be moved on the potentiometer. The bottom plate is provided with a rail. The rail is configured to limit the first pulleys to roll thereon.

The cover is located on top of the linking unit. A part of the bottom surface of the cover is in contact with and supported by the second pulleys. A higher side of the first body is provided with at least one first hinge. The first hinge is connected with the cover.

A soft cushion is provided on top of the cover.

In the present invention, the X-shaped linking unit is lifted by the driven arcuate gear with the push arm. This action is a direct push, and there is no power consumption. Only a small motor is required for actuation. Space and energy consumption are optimized by the direct push. For a conventional lifting apparatus, there will be a problem of torque conversion and a large loss of energy. In particular, in the beginning the structure is almost horizontal to be pushed up vertically. The push force should be about 7-10 times of the weight of the load. The motor is large in size, and it is very noisy to affect sleep. Obviously, the present invention is very ideal.

### BRIEF DESCRIPTION OF THE DRAWINGS

FIG. 1 is an exploded view of the present invention;

FIG. 2 is a perspective view of the present invention;

FIG. 3 is a partial structural view of the present invention;

FIG. 4 is another partial structural view of the present invention;

FIG. 5 is a further partial structural view of the present invention;

FIG. 6 is a side sectional view of the present invention;

FIG. 7 is a side sectional view of the present invention in a lifting state;

FIG. 8 is a perspective view of the present invention in a lifting state;

FIG. 9 is a schematic view showing the position detection when the present invention is lifted; and

FIG. 10 is a schematic view of the present invention covered with a soft cushion.

### DETAILED DESCRIPTION OF THE PREFERRED EMBODIMENTS

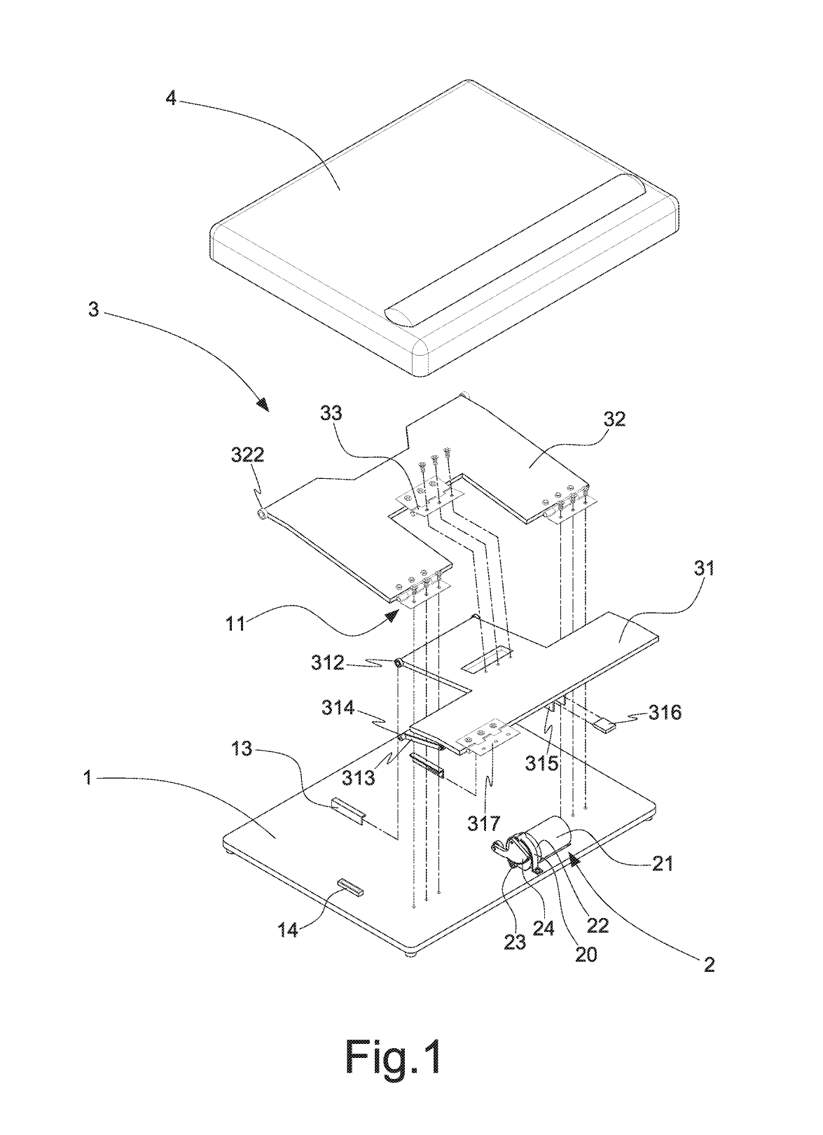

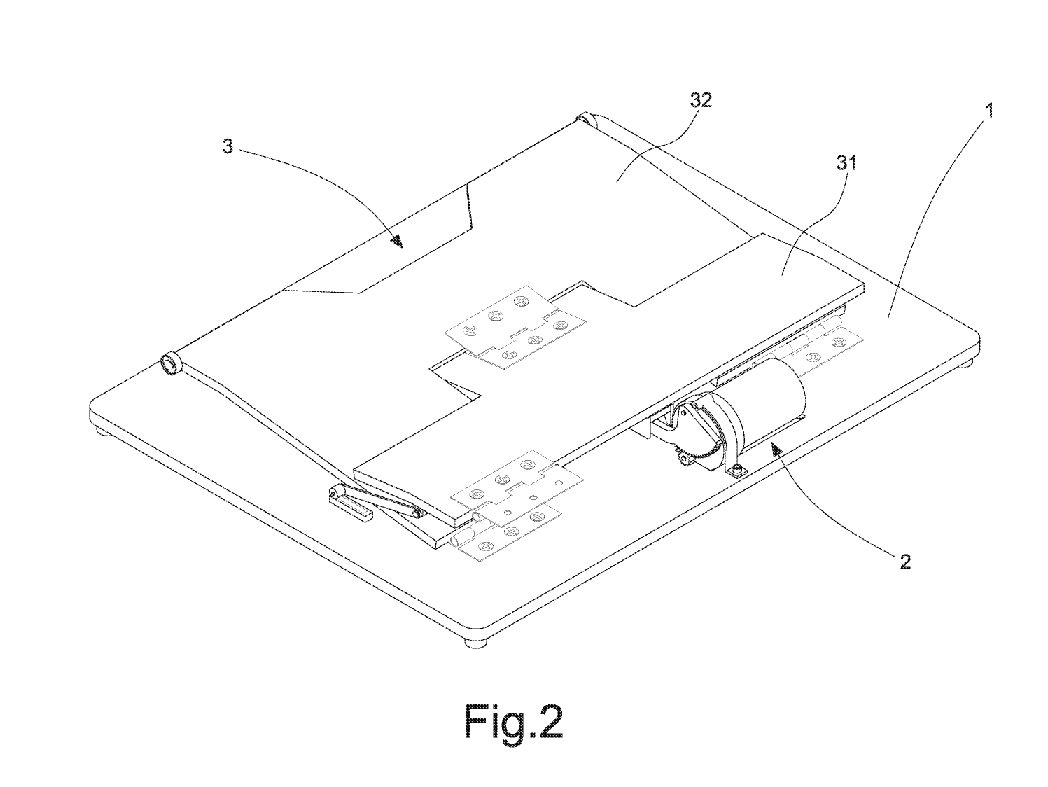

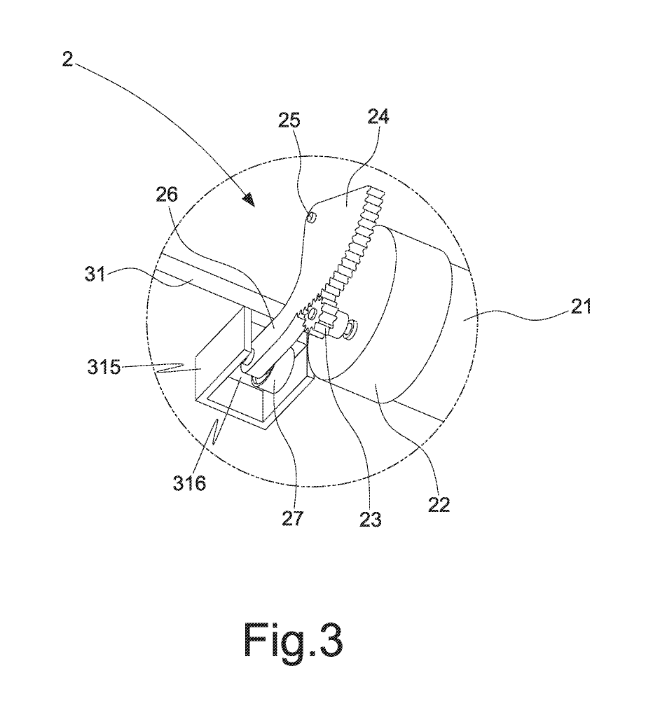

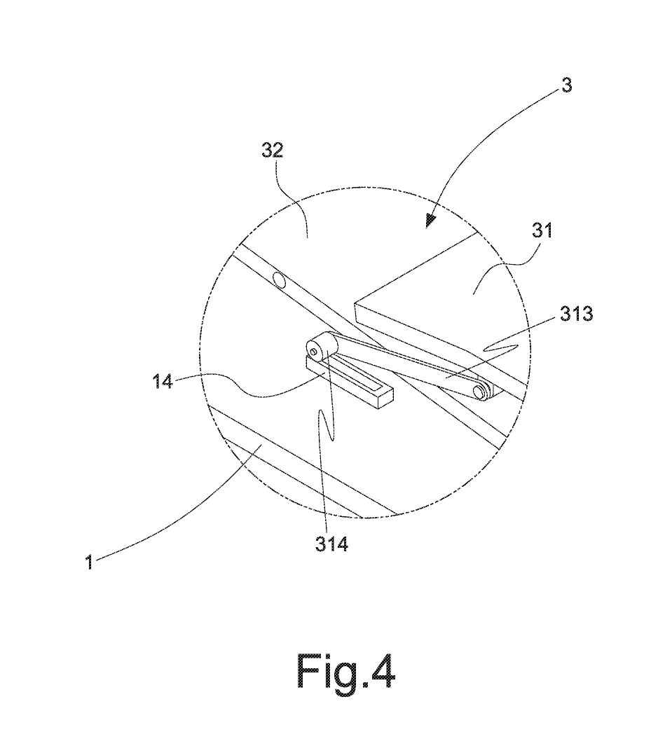

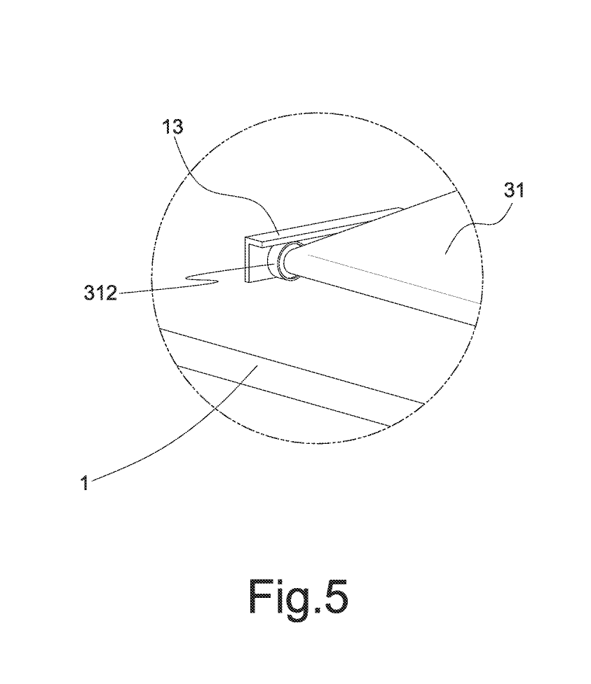

Referring to FIG. 1 through FIG. 6, the pillow lifting structure of the present invention comprises a bottom plate 1. The bottom plate 1 is provided with a power unit 2. The power unit 2 is connected to a linking unit 3. The top of the linking unit 3 is covered with a cover 4. The power unit 2 is disposed on the bottom plate 1. The power unit 2 includes a motor 21. An output end of the motor 21 is connected to a speed reducer 22. An output end of the speed reducer 22 is connected to a driving gear 23. The driving gear 23 is meshed with a driven arcuate gear 24. A rotating shaft portion 25 is disposed at the arc center of the driven arcuate gear 24. The rotating shaft portion 25 is axially mounted to a fixing seat 20 beside the speed reducer 22. The driven arcuate gear 24 is connected with a push arm 26. The distal end of the push arm 26 is provided with a pulley 27. The linking unit 3 includes a first body 31 and a second body 32. The first body 31 is in the form of a Chinese character “ [symbol] ”. The second body 32 is in the form of a Chinese character “ [symbol] ”. The first body 31 and the second body 32 are engaged with each other to form an X shape. Two ends of a lower side of the first body 31 are provided with first pulleys 312. One side of the first body 31 is provided with a side plate 313. A side pulley 314 is connected to the distal end of the side plate 313. The bottom surface of the first body 31 is provided with a guide rail 315. The guide rail 315 is provided with a wear plate 316. The wear plate 316 is located on the top edge of the pulley 27 of the push arm 26 of the power unit 2. Two ends of a higher side of the second body 32 are provided with second pulleys 322. A central hinge 33 is provided at the junction of the first body 31 and the second body 32. The bottom plate 1 is a flat plate. The bottom plate 1 is provided with at least one second hinge 11 connected with the lower side of the second body 32. The at least one second hinge 11 provides axial movement of the second body 32 relative to the bottom plate 1. The bottom plate 1 is provided with a potentiometer 14. The side pulley 314 can be moved on the potentiometer 14. The bottom plate 1 is provided with a pair of rails 13. The pair of rails 13 is configured to limit the first pulleys 312 to roll thereon. The cover 4 is located on top of the linking unit 3. A part of the bottom surface of the cover 4 is in contact with and supported by the second pulleys 322. A higher side of the first body 31 is provided with at least one first hinge 317. The first hinge 317 is connected with the cover 4.

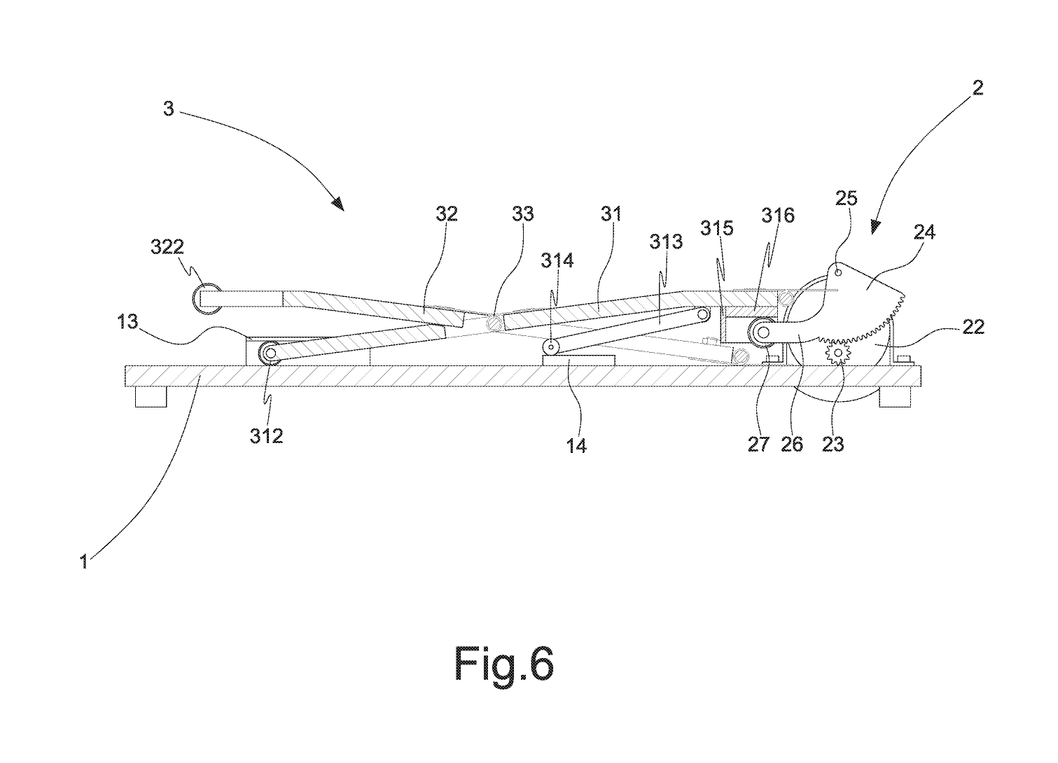

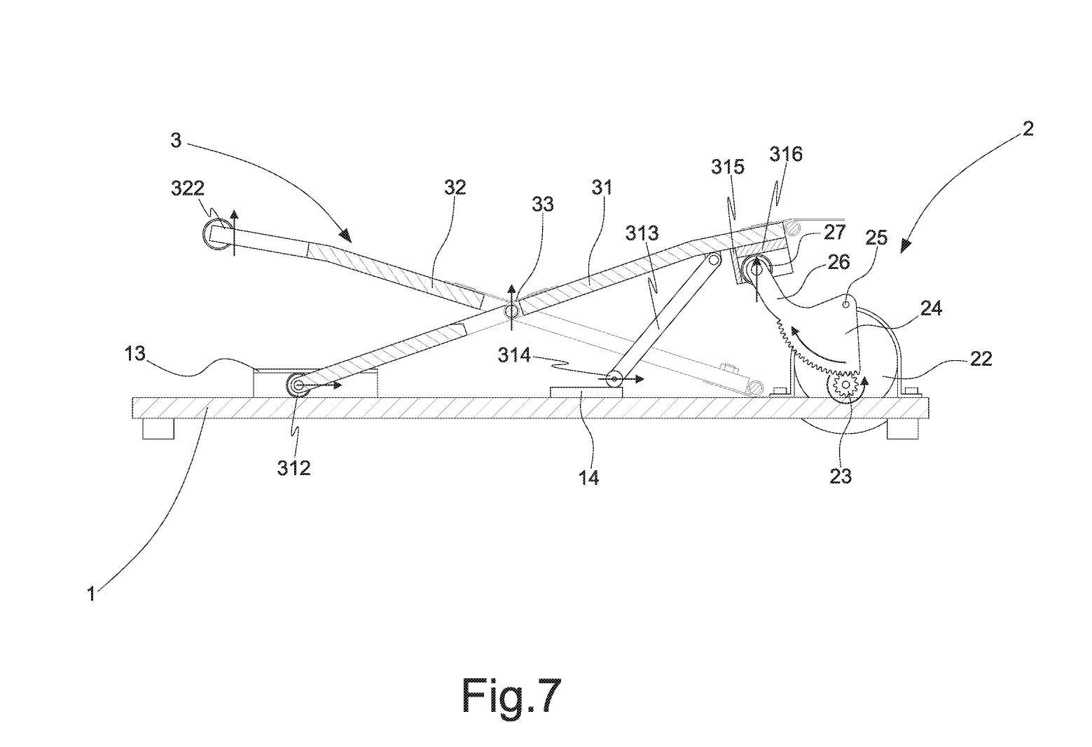

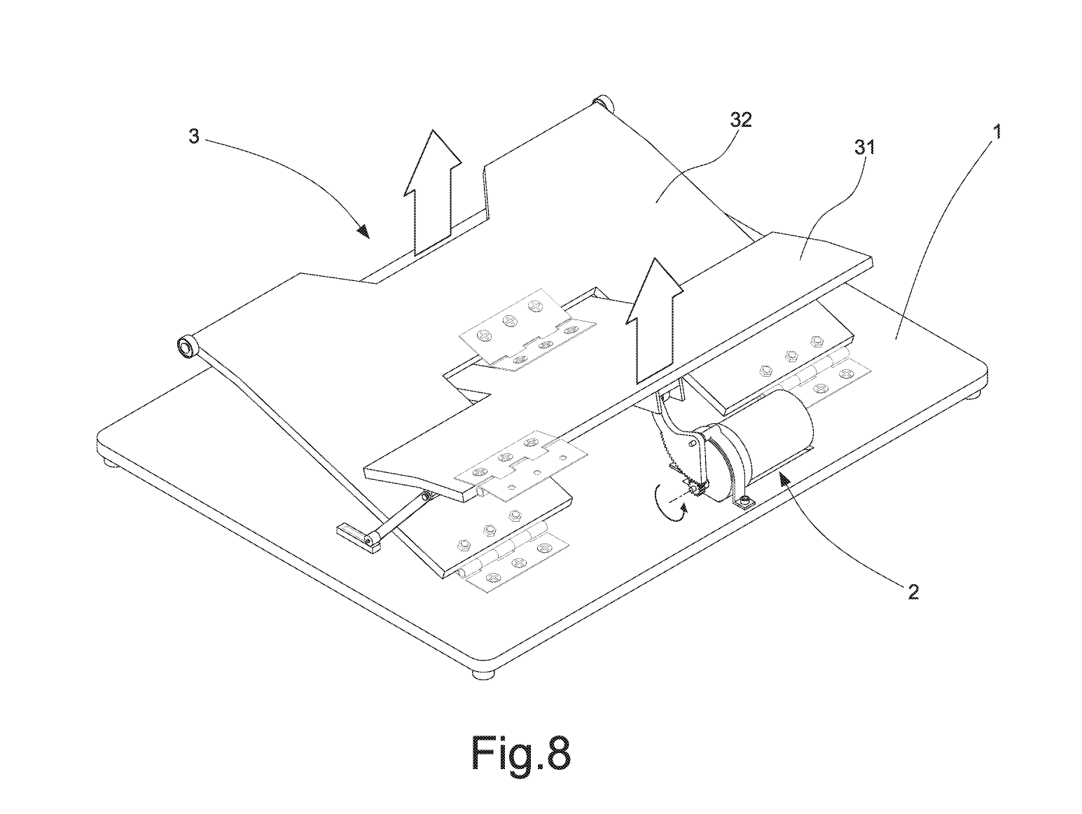

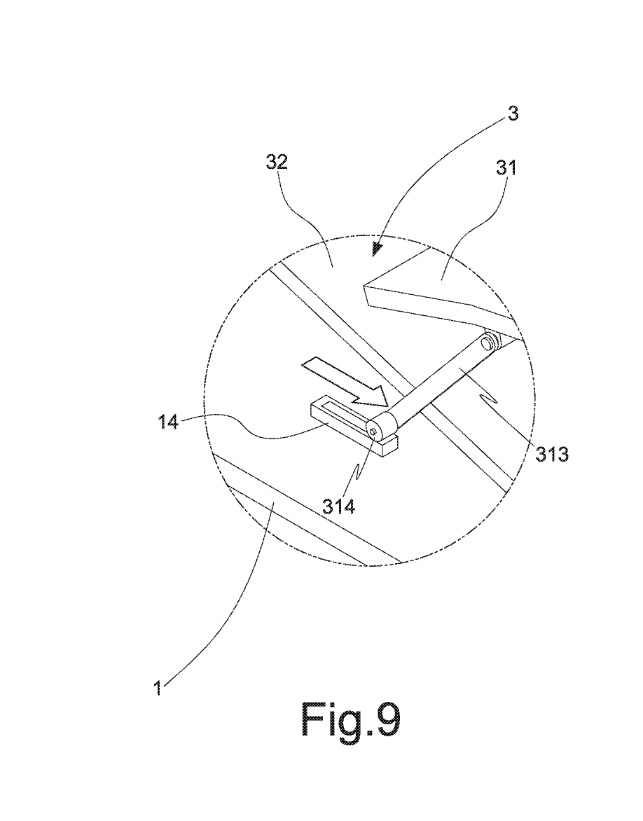

FIG. 6 is a schematic view of the pillow of the present invention at the lowest position. When the pillow is to be lifted, as shown in FIG. 7 and FIG. 8, the motor 21 of the power unit 2 is actuated, and the driving gear 23 is rotated after decelerating by the speed reducer 22 and increasing the thrust. The driven arcuate gear 24 in meshing relationship with the driving gear 23 will be linked to change the position and angle, and then the push arm 26 is linked to move the pulley 27. At the same time, the pulley 27 will lift relative to the guide rail 315 of the first body 31. Since the first body 31 and the second body 32 are in a linked relationship through the central hinge 33, when one end of the first body 31 is lifted, under the control of the second hinge 11 connected to the bottom plate 1, the first body 31 and the second body 32 as a whole will rise synchronously, and the side pulley 314 will move on the potentiometer 14 to detect the relative moving position (as shown in FIG. 9). Finally, the purpose of lifting is completed. On the contrary, when the pillow is to be lowered, the motor 21 is rotated reversely, and the height of the pillow is lowered in accordance with the above principle.

In the present invention, the extent of lifting and lowering can be slightly adjusted as desired according to the actuation of the motor 21, and the potentiometer 14 is used to detect the relative state and position of the movement. During the displacement, the system can control the height of lifting and lowering through the electrical information of the potentiometer 14. The height required for different sleeping postures of the user can be preset, and the automatic adjustment can be performed to achieve a height change.

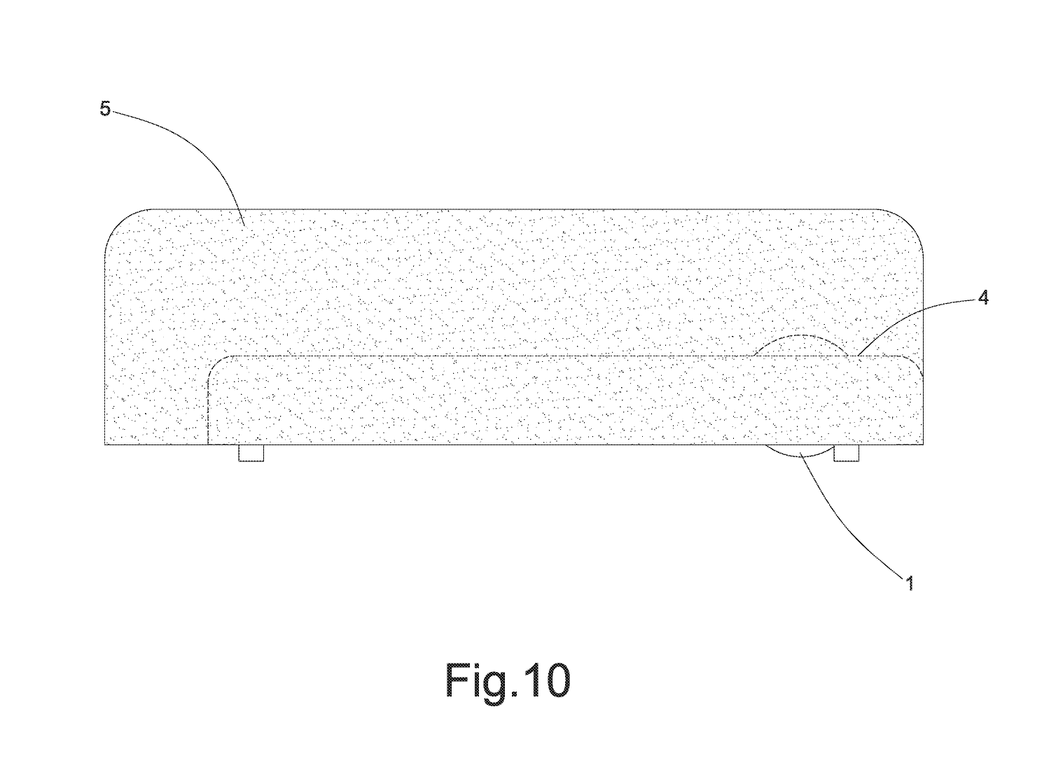

As shown in FIG. 10, in the implementation of the present invention, a soft cushion 5 is provided on top of the cover 4.

In summary, the pillow lifting structure of the present invention can achieve the purpose of individually setting and automatically adjusting the height of the pillow with a miniaturized mechanism, which can improve the sleep quality of the user effectively.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A pillow lifting structure, comprising:
a power unit, the power unit including a motor, an output end of the motor being connected to a speed reducer, an output end of the speed reducer being connected to a driving gear, the driving gear being meshed with a driven arcuate gear, a rotating shaft portion being disposed at an arc center of the driven arcuate gear, the rotating shaft portion being axially mounted to a fixing seat beside the speed reducer; the driven arcuate gear being connected with a push arm;
a linking unit, the linking unit including a first body and a second body that are engaged with each other to form an X shape; a central hinge being provided at the junction of the first body and the second body; the push arm being located at a bottom edge of the first body;
a bottom plate, the bottom plate being a flat plate, the bottom plate being provided with at least one second hinge, the second hinge being connected with a lower side of the second body so that the linking unit and bottom plate are connected; the power unit being mounted to the bottom plate;
a cover, the cover being located on top of the linking unit, a higher side of the first body being provided with at least one first hinge, the first hinge being connected with the cover;
wherein the power unit is actuated to move the linking unit up and down via displacement of the push arm.

2. The pillow lifting structure as claimed in claim 1, wherein a distal end of the push arm is provided with a pulley, a bottom surface of the first body is provided with a guide rail, the guide rail is provided with a wear plate, and the wear plate is located on a top edge of the pulley of the push arm of the power unit.

3. The pillow lifting structure as claimed in claim 1, wherein the first body is in the shape of a Chinese character “ [symbol] ”, the second body is in the shape of a Chinese character “ [symbol] ”, and the first body and the second body are engaged with each other to form the X shape.

4. The pillow lifting structure as claimed in claim 1, wherein two ends of the lower side of the first body are provided with first pulleys.

5. The pillow lifting structure as claimed in claim 1, wherein one side of the first body is provided with a side plate, a side pulley is connected to a distal end of the side plate; and the bottom plate is provided with a potentiometer.

6. The pillow lifting structure as claimed in claim 1, wherein two ends of a higher side of the second body are provided with second pulleys.

7. The pillow lifting structure as claimed in claim 1, wherein a soft cushion is provided on top of the cover.

8. The pillow lifting structure as claimed in claim 4, wherein the bottom plate is provided with at least one rail, and the rail is configured to limit the first pulleys to roll thereon.
